(19) United States
(12) Patent Application Publication
(10) Pub. No.: US 2014/0301565 A1
(43) Pub. Date: Oct. 9, 2014

(54) Vehicle Sound Signal and Method

(71) Applicant: Paul Dorland, St. Catharines (CA)

(72) Inventors: Paul Dorland, St. Catharines (CA); Ayaz Somani, Markham (CA)

(21) Appl. No.: 14/346,416

(22) PCT Filed: Sep. 26, 2012
(86) PCT No.: PCT/CA2012/000879

§ 371 Date: Mar. 21, 2014

Related U.S. Application Data
(60) Provisional application No. 61/539,048, filed on Sep. 26, 2011.

(51) Int. Cl. B60W 10/30; H04R 3/00

(52) U.S. Cl. CPC B60W 10/30; H04R 3/00
USPC 381/86

(57) ABSTRACT

A sound signal system for a motor vehicle having a remote control locking mechanism comprises a receiver configured to receive a wireless signal sent by a remote control device, where the receiver is configured to generate an actuating signal upon receiving the wireless signal; and an audio signal controller in communication with the receiver and configured to output a designated audio signal to a sound generator upon receiving the actuating signal. The sound generator produces a sound signal upon receiving the designated audio signal. The receiver, the audio signal controller, and the sound generator are original equipment manufacturer (OEM) components of the vehicle.

### FIELD OF THE INVENTION

The present invention relates generally to sound systems for vehicles and in particular, to a vehicle sound signal system and method.

### BACKGROUND OF THE INVENTION

Motor vehicles such as automobiles are typically equipped with remote control devices, sometimes referred to as “fobs”, for remotely actuating the vehicle's door locking mechanism to lock and unlock doors of the vehicle. Typically, the remote control device also remotely actuates an anti-theft security system of the vehicle. Such remote control devices are typically equipped with one or more buttons, which when depressed cause the remote control device to transmit a low-power radio frequency signal for actuating the door locking mechanism of the vehicle.

While such remote control devices are relatively simple to operate, they do have limitations. If a button is pressed with insufficient force, the remote control device will not generate the radio frequency signal. It is also possible to misapply the button such that two separate consecutive signals are generated, by a which a user intending to lock his or her vehicle may inadvertently unlock it again. Additionally, on remote control devices having separate buttons for locking and unlocking the vehicle, it is also possible to inadvertently press the wrong button.

A user may also question whether he or she has remembered to actuate the vehicle's door locking mechanism after parking the vehicle and walking some distance away. Many such remote control devices are operable over distances of 100 feet or more from the vehicle. However, as will be appreciated, the signal may become unreliable with increasing distance from the vehicle. If a user can see the interior door lock stems of the vehicle, he or she can visually determine if the remote control device has operated as intended. However, often when the remote control device is used the user cannot see the interior door lock stems, either because he or she is too far away or because his or her view is obstructed.

To address this issue, vehicle manufacturers typically include features with door locking mechanisms that cause the vehicle's headlights and taillights to flash, and the vehicle's horn to sound, when the remote control device is operated.

Sounding of the vehicle's horn allows the user to determine whether the remote control device has been properly operated, and its signal properly received by the vehicle's door locking mechanism. Sounding of the horn also enables a user to locate his or her vehicle when he or she returns to a large and crowded parking area. Many users may remember only the general vicinity in which they have parked their vehicle and, unless they are able to see it, may experience some difficulty determining its exact location. Rather than searching numerous rows of vehicles, sounding of the vehicle's horn through operation of the remote control device can provide a quick and easy approach to locating the vehicle.

However, car horns often sound similar. If two or more vehicle operators simultaneously operate their remote control devices, it may be difficult to distinguish one vehicle's horn from the other. Similarly, when a user uses the remote control to lock his or her vehicle while walking away from it, the sounding of a horn may not necessarily be identifiable as coming from his or her own vehicle.

Sound signal systems for vehicles are known. For example, U.S. Pat. No. 7,564,342 to Klein discloses an audio signal system for a vehicle remote locking mechanism that provides an audio signal that is more intricate than a simple, sounding of the vehicle's horn or beep tone.

U.S. Pat. No. 6,744,364 to Wathen discloses a distance sensitive remote control system that includes a remote control transmitter that transmits a signal, and a receiver than can receive the signal from the transmitter.

Sound signal systems for vehicles may be sold as “after-market” accessories to be installed in a vehicle after its manufacture. As will be appreciated, such systems may interfere with the integrity of existing original equipment manufacturer (OEM) components in the vehicle, and may also interfere with insurance and/or warranty requirements relating to the use of original equipment manufacturer (OEM) components.

Improvements are generally desired. It is therefore an object at least to provide a novel vehicle sound signal system and method.

### SUMMARY OF THE INVENTION

In one aspect, there is provided a sound signal system for a motor vehicle having a remote control locking mechanism, comprising: a receiver configured to receive a wireless signal sent by a remote control device, the receiver configured to generate an actuating signal upon receiving the wireless signal; and an audio signal controller in communication with the receiver and configured to output a designated audio signal to a sound generator upon receiving the actuating signal, the sound generator producing a sound signal upon receiving the designated audio signal, wherein the receiver, the audio signal controller, and the sound generator are original equipment manufacturer (OEM) components of the vehicle.

The system may further comprising a display in an interior of the vehicle and in communication with the audio signal controller, the display being configured to display one or more audio data files, the designated audio signal corresponding to a selected one of the one or more audio data files. The display may be an original equipment manufacturer (OEM) component of the vehicle. The display may comprise a touch screen configured to receive touch input for selection of the designated audio signal. The display may have an input device associated therewith, the input device being configured to receive input for selection of the designated audio signal. The input device may comprise at least one physical button. The system may further comprise a digital connection port in the interior of the vehicle, the digital connection port being in communication with the audio signal controller for transfer of at least one of the one or more audio data files to a computer-readable medium. The digital connection port may comprise one or more of a Universal System Bus (USB) connector, a tip ring sleeve (TRS) connector, a memory card reader, a wireless transmitter/receiver, and a connection to a satellite broadcasting network. The system may further comprise an audio data storage in communication with the audio signal controller for storing the one or more audio data files. The audio data storage may be an original equipment manufacturer (OEM) component of the vehicle. The system may further comprise a digital connection port in the interior of the vehicle, the digital connection port being in communication with the audio data storage for transfer of at least one of the one or more audio data files to a computer-readable medium. The digital connection port may comprise one or more of a Universal System Bus (USB) connector, a tip ring sleeve (TRS) connector, a memory card reader, a wireless transmitter/receiver, and a connection to a satellite broadcasting network. Each of the one or more audio data files may be a music file or a recorded sound file.

The audio signal controller may send the designated audio signal to an amplifier for amplification prior to output by the sound generator.

In another aspect, there is provided a method of operating a sound signal system for a motor vehicle having a remote control locking mechanism, comprising: receiving a wireless signal using a receiver; actuating a locking mechanism based upon the receiver receiving the wireless signal; and playing a designated audio data file exterior the vehicle using a sound generator based upon the receiver receiving the wireless signal, wherein the receiver and the sound generator are original equipment manufacturer (OEM) components of the vehicle.

The method may further comprise: displaying one or more audio data files on a display in the interior of the vehicle; and storing a selected one of the one or more audio data files as the designated audio data file. The display may be an original equipment manufacturer (OEM) component of the vehicle. The display may be a touch screen configured to receive touch input, the method further comprising: selecting the selected one of the one or more audio data files using the touch screen. The display may have an input device associated therewith configured to receive input, the method further comprising: selecting the selected one of the one or more audio data files using the input device. The input device may comprise at least one physical button. Each of the one or more audio data files may be a music file or a recorded sound file.

The method may further comprise amplifying the designated audio signal using an amplifier prior to playing using the sound generator.

The actuating may comprise at least one of locking the locking mechanism and unlocking the locking mechanism.

### BRIEF DESCRIPTION OF THE DRAWINGS

Embodiments will now be described more fully with reference to the accompanying drawings in which:

FIG. 1 is a block diagram of a vehicle sound signal system; and

FIG. 2 is a screen shot of an exemplary audio data file selection page presented by the vehicle sound signal system of FIG. 1.

### DETAILED DESCRIPTION OF THE EMBODIMENTS

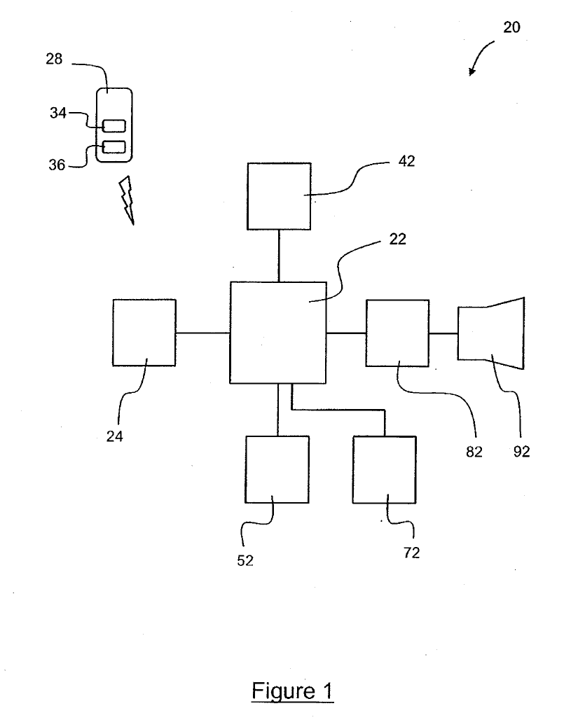

Turning now to FIG. 1, a vehicle sound signal system is shown and is generally indicated by reference numeral 20. System 20 is for use in a motor vehicle, such as for example an automobile. System 20 comprises an audio signal controller 22 that is in communication with a remote keyless entry receiver 24. The audio signal controller 22 includes processing structure that is configured to play a designated audio data file upon receiving an actuating signal from the remote keyless entry receiver 24. In this embodiment, the processing structure comprises a central processing unit (CPU) (not shown) and supporting circuitry (not shown), however those skilled in the art will understand that other forms of processing structure may alternatively be used. The audio signal controller 22 and the remote keyless entry receiver 24 are original equipment manufacturer (OEM) components of the vehicle.

The remote keyless entry receiver 24 comprises an-antenna (not shown) and supporting circuitry (not shown) that are configured to receive a wireless signal transmitted by a remote control device 28 for actuating a door locking mechanism (not shown) of the vehicle. In this embodiment, the remote keyless entry receiver 24 is configured to receive a radio frequency signal transmitted by the remote control device 28, while the remote control device 28 forms part of an electronic key, or “smart key”, of the vehicle and is equipped with a radio frequency transmitter. In the embodiment shown, the remote control device 28 comprises a first button 34 and a second button 36, each of which may be selected for causing the remote control device 28 to transmit a respective wireless, radio frequency signal for locking and unlocking the locking mechanism, respectively.

The remote keyless entry receiver 24 is in communication with authentication circuitry (not shown) comprising one or more identification codes that are unique to the remote control device and to the vehicle. The remote keyless entry receiver 24 is configured to authenticate the signal received from the remote control device 28 by processing the signal and comparing it to the one or more identification codes, as is known in the art. Upon authentication of the received signal, the remote keyless entry receiver 24 is configured to generate the actuating signal and to send it to the audio signal controller 22.

The audio signal controller 22 is also in communication with audio data storage 42, which comprises a computer-readable medium configured to store one or more digital audio data files. In this embodiment, the audio data storage 42 is in the form of random access memory (RAM), however those skilled in the art will understand that other forms of computer-readable media capable of storing digital files may alternatively be used, such as for example a hard drive. The audio data files may be stored in any suitable digital audio format, such as for example, MP3, AIFF, WAV, MPEG-4, AAC and M4A formats. The audio data storage 42 is an OEM component of the vehicle.

The audio signal controller 22 is also in communication with a display 52 that is positioned in the interior of the vehicle, and which is configured to display the names of the audio data files stored in the audio data storage 42. In this embodiment, the display 52 is a touch screen mounted on the dashboard of the vehicle, and comprises a surface that is configured to receive touch input from a user. The display 52 is an OEM component of the vehicle.

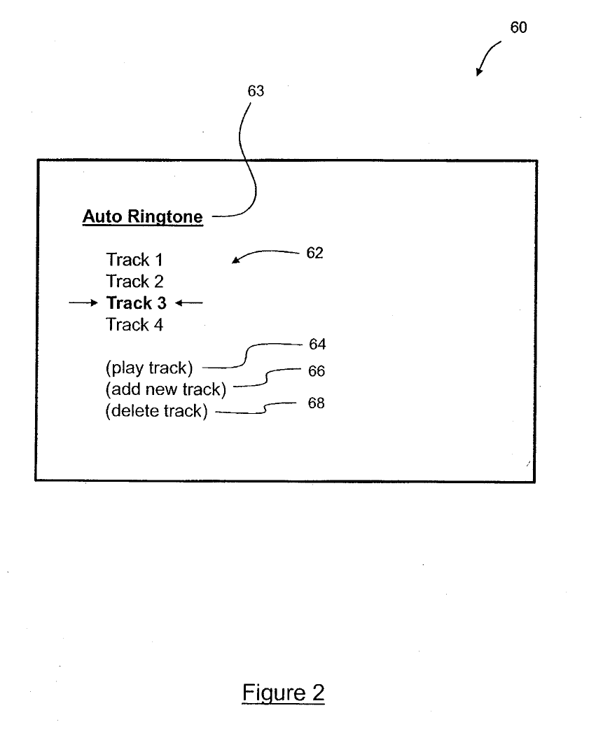

The system 20 is configured to present an audio data file selection page on the display 52. FIG. 2 shows a screen shot of an exemplary audio data file selection page presented on the display 52, and which is generally indicated by reference numeral 60. In the example shown, the audio data files available for selection are presented as a list 62 under a heading 63 of “Auto Ringtone”, and in the example shown, the available audio data files are named “Track 1”, “Track 2”, “Track 3” and “Track 4”. Upon selection of one of the audio data files, the audio signal controller 22 is configured to set the selected audio data file as the designated audio data file. In the example shown, the audio data file named “Track 3” has been selected through touch input on the display 52, and as a result the audio signal controller 22 has set this audio data file as the designated audio data file. Audio data file selection page 60 also comprises a “play track” virtual button 64, which may be selected to play the designated audio data file on the interior audio speaker system (not shown) of the vehicle, such as for example to assist a user in selecting the designated audio data file. Audio data file selection page 60 also comprises an “add new track” virtual button 66, which may be selected to transfer an additional audio data file from another medium to audio data storage 42, as described below. Audio data file selection page 60 also comprises a “delete track” virtual button 68, which may be selected to delete an audio data file from the audio data storage 42.

The audio data file selection page 60 may, for example, be selected as a page of a menu system that is available within an interactive display system of the vehicle, and may for example be accessed according to the following menu path: Entertainment/Sounds/Settings/Auto Ringtone. However, as will be understood, the menu system of each vehicle make and model may differ, and the menu path provided above is merely exemplary. Similarly, the configuration of the audio data file selection page shown in FIG. 2 is merely exemplary, and it will be understood that the configuration of the audio data file selection page may differ from that shown in FIG. 2.

The audio signal controller 22 is also in communication with a digital connection port 72 that is positioned in the interior of the vehicle. The digital connection port 72 is configured to provide a connection to a computer-readable medium for transfer of one or more audio data files between the audio data storage 42 and the computer-readable medium. In this embodiment, the digital connection port 72 is in the form of a Universal Serial Bus (USB) connector, and is configured to connect to a USB memory stick (not shown) comprising a computer-readable medium storing one or more additional audio data files. The digital connection port 72 is an OEM component of the vehicle.

The audio signal controller 22 is in communication with an amplifier 82 that is connected to a sound generator 92. Upon receiving the actuating signal, the audio signal controller 22 is configured to retrieve the designated audio data file from the audio data storage 42 and to output the designated audio data file to the amplifier 82 as an electronic, designated audio signal. The amplifier in turn amplifies the signal and outputs it to the sound generator 92 which produces a sound signal that is audible from outside of the vehicle. In this manner, the sound generator 92 is configured to produce a sound signal corresponding to the designated audio data file. In this embodiment, the sound generator 92 is a loudspeaker that is positioned on the exterior of the vehicle, and in particular under the hood of the vehicle. The sound generator 92 is capable of producing complex sound signals over a wide range of frequencies and volumes, and can therefore produce an essentially infinite number of different sound signals. Accordingly, the vehicle sound signal system may provide a nearly limitless range of different sound signals by which a user can readily verify that his or her vehicle's door locking mechanism has been activated or deactivated. As will be appreciated, because of the wide range of sound signals that are potentially available, the sound signals of different vehicle may be readily distinguished. The amplifier 82 and the sound generator 92 are OEM components of the vehicle.

During use, a user accesses the audio data file selection page 60 and selects one of the digital audio data files listed therein as the designated audio data file. When the remote control device 28 is operated, it sends a radio frequency signal to the remote keyless entry receiver 24 of the vehicle. The remote keyless entry receiver 24 processes the signal to authenticate the sender of the signal and, upon authenticating the signal, sends an actuating signal to the audio signal controller 22. Upon receiving the actuating signal, the audio signal controller 22 retrieves the designated audio data file from the audio data storage 42, and outputs the designated audio data file to the amplifier 82 as an electronic, audio data signal. The amplifier 82 in turn amplifies the signal and outputs it on the sound generator 92. In this manner, the sound generator produces a sound signal corresponding to the designated audio data file.

As will be appreciated, displaying the one or more audio data files on the display advantageously allows the available audio data files to be easily browsed, and also advantageously allows the designated audio data file to be selected in a facile, user-friendly manner. As will be understood, this also advantageously allows the designated audio data file to be easily changed to a different audio data file, such as for example when the operator of the vehicle changes, in the same facile, user-friendly manner.

As will be appreciated, the use of original equipment manufacturer (OEM) components in the vehicle sound signal system advantageously allows the system to be installed during manufacture of the vehicle. As a result, the vehicle sound signal system will advantageously not interfere with the integrity of other original equipment manufacturer (OEM) components in the vehicle. Additionally, the vehicle sound signal system and its components will advantageously comply with any insurance and/or warranty requirements relating to use of OEM components. Additionally, the use of OEM components in the vehicle sound signal system advantageously allows the system to comply with international certification standards, such as for example the ISO 9001 standard, published by the International Organization for Standardization.

In the embodiment described above, the audio signal controller and the remote keyless entry receiver, the audio data storage, the display, the digital connection port and the amplifier are in communication via wired connection. However those skilled in the art will understand that, in other embodiments, the audio signal controller and one or more of the remote keyless entry receiver, the audio data storage, the display, the digital connection port and the amplifier may alternatively be in communication with each other via wireless connection.

Although in embodiments described above, the display is a touch screen mounted on the dashboard of the vehicle, and comprises a surface that is configured to receive touch input from a user, in other embodiments, the display may alternatively not be a touch screen. For example, in one such embodiment, the display may alternatively be a conventional display that is not configured to receive touch input, and that has an input device associated therewith. For example, in one embodiment, the display may be a conventional flat panel display (e.g. a liquid crystal display (LCD), a light emitting diode (LED) display, and the like) having an input device comprising one or more physical buttons that are positioned adjacent the display. In this embodiment, information presented on the display, such as for example the names of available audio data files, would be selected through selection of the one or more physical buttons. It will be understood that the input device could take other forms, such as for example, one or more dials.

Although in embodiments described above, the display is a touch screen mounted on the dashboard of the vehicle, in other embodiments, the display may alternatively be positioned elsewhere within the interior of the vehicle. For example, in one embodiment, the display may be a display screen of a portable electronic device that is in communication with the audio signal controller. The portable electronic device may be, for example, a mobile phone, a smartphone, a PDA, a digital media player, and the like, and the portable electronic device may be in communication with the audio signal controller via the digital connection port, for example, or via another wired or wireless connection available within the vehicle.

Although in embodiments described above, the vehicle sound signal system comprises a display, in other embodiments, the vehicle sound signal system may alternatively not comprise a display. In such embodiments, the designated audio data file may be selected in other ways. For example, in one such embodiment, the audio data storage may alternatively store only a single audio data file, which the audio signal controller sets as the designated audio data file; in such an exemplary embodiment, user selectivity of the designated audio data file would be achieved through selection of the single audio data file to be transferred to the audio data storage.

Although in embodiments described above, the remote keyless entry receiver is configured to receive a wireless, radio frequency signal transmitted by the remote control device, and the remote control device is equipped with a radio frequency transmitter, in other embodiments, the remote keyless entry receiver may alternatively be configured to receive another form of wireless signal, such as for example an infrared signal, and the remote control device may alternatively be equipped with another form of wireless signal transmitter, such as for example an infrared signal transmitter.

Although in embodiments described above, the remote control device forms part of an electronic key or “smart key” of the vehicle, in other embodiments, the remote control device may alternatively be a key fob for use with a conventional vehicle key. In still other embodiments, the remote control device may be any device configured to send a wireless signal for being received by the remote keyless entry receiver of the vehicle, such as for example, a smartphone, a wristwatch, or any other suitable, portable electronic device intended for use with a remote keyless entry receiver of a motor vehicle.

Although in embodiments described above, the remote control device comprises a first button and a second button, each of which may be selected for causing the remote control device to transmit a respective wireless, radio frequency signal for locking and unlocking the locking mechanism, respectively, in other embodiments, the remote control device may alternatively have fewer or more buttons which may be selected for causing the remote control device to transmit a corresponding respective wireless signals. For example, the remote control device may alternatively comprise four (4) buttons, each of which may be selected for transmitting first, second, third and fourth wireless signals, respectively. In this embodiment, the first, second, third and fourth wireless signals may be used for locking the locking mechanism, unlocking the locking mechanism, opening the luggage compartment door, and activating the vehicle “panic” system, respectively.

Although in embodiments described above, the remote control device comprises one or more buttons, each of which may be selected for causing the remote control device to transmit a respective wireless, radio frequency signal for locking and unlocking the locking mechanism, in other alternative embodiments, the remote control device may continuously or periodically transmit a wireless signal, such that when the remote control device is within a threshold distance from the remote keyless entry receiver, the wireless signal is received by the remote keyless entry receiver. As will be understood, in this embodiment, the vehicle sound signal system could operate in an “automatic” or “proximity” detection mode, such that when a user carrying the remote control device is within the threshold distance from the remote keyless entry receiver, the sound generator would produce a sound signal corresponding to the designated audio data file.

Although in embodiments described above, the audio data storage is in the form of random access memory (RAM), in other embodiments, the audio data storage may comprise another computer-readable medium that is capable of storing digital files, such as for example a hard disk drive, an optical digital storage medium (e.g. CD-ROM, DVD), flash memory, and the like.

Although in embodiments described above, the digital connection port is in the form of a Universal Serial Bus (USB) connector configured to connect to a computer-readable medium in the form of a USB memory stick storing one or more additional audio data files, in other embodiments, the digital connection port may alternatively take other forms. For example, in other embodiments, the digital connection port may be any device, port or connector that is configured to connect to a computer-readable medium storing one or more additional audio data files, such as for example, a tip ring sleeve (TRS) connector, a memory card reader, and a wireless connection. The wireless connection may be any wireless connection, such as for example, Ethernet, Wi-Fi™, Bluetooth™ and the like. In still other embodiments, the digital connection port may comprise a connection to a satellite broadcasting network, through which additional audio data files could be transferred to the vehicle sound signal system by satellite transmission from the satellite broadcasting network.

Although in embodiments described above, the sound generator is a loudspeaker that is positioned on the exterior of the vehicle, and in particular under the hood of the vehicle, in other embodiments, the sound generator may alternatively be positioned elsewhere on the exterior of the vehicle, or in the interior of the vehicle. In still other embodiments, the sound generator may not be a loudspeaker, but may alternatively be another device configured to produce sound from an electronic audio signal.

Although in embodiments described above, the vehicle sound signal system comprises an amplifier connected to the sound generator, in other embodiments, the vehicle sound signal system may alternatively not comprise an amplifier. In such embodiments, the audio signal controller may alternatively output the designated audio data file as an electronic, designated audio signal to the sound generator. In still other embodiments, the audio signal controller may alternatively comprise an amplifier, and the audio signal controller may alternatively output an amplified, electronic, designated audio signal to the sound generator.

Although embodiments have been described above with reference to the accompanying drawings, those of skill in the art will appreciate that variations and modifications may be made without departing from the scope thereof as defined by the appended claims.

What is claimed is:

1. A sound signal system for a motor vehicle having a remote control locking mechanism, comprising:
a receiver configured to receive a wireless signal sent by a remote control device, said receiver configured to generate an actuating signal upon receiving the wireless signal; and
an audio signal controller in communication with said receiver and configured to output a designated audio signal to a sound generator upon receiving said actuating signal, said sound generator producing a sound signal upon receiving said designated audio signal, wherein said receiver, said audio signal controller, and said sound generator are original equipment manufacturer (OEM) components of said vehicle.

2. The system of claim 1, further comprising a display in an interior of said vehicle and in communication with the audio signal controller, said display being configured to display one or more audio data files, the designated audio signal corresponding to a selected one of said one or more audio data files.

3. The system of claim 2, wherein said display is an original equipment manufacturer (OEM) component of said vehicle.

4. The system of claim 2 or 3, wherein said display comprises a touch screen configured to receive touch input for selection of the designated audio signal.

5. The system of claim 2 or 3, wherein said display has an input device associated therewith, said input device being configured to receive input for selection of said designated audio signal.

6. The system of claim 5, wherein said input device comprises at least one physical button.

7. The system of any one of claims 2 to 6, further comprising a digital connection port in the interior of said vehicle, said digital connection port being in communication with said audio signal controller for transfer of at least one of said one or more audio data files to a computer-readable medium.

8. The system of claim 7, wherein said digital connection port comprises one or more of a Universal System Bus (USB) connector, a tip ring sleeve (TRS) connector, a memory card reader, a wireless transmitter/receiver, and a connection to a satellite broadcasting network.

9. The system of any one of claims 2 to 6, further comprising an audio data storage in communication with said audio signal controller for storing said one or more audio data files.

10. The system of claim 9, wherein said audio data storage is an original equipment manufacturer (OEM) component of said vehicle.

11. The system of claim 9 or 10, further comprising a digital connection port in the interior of said vehicle, said digital connection port being in communication with said audio data storage for transfer of at least one of said one or more audio data files to a computer-readable medium.

12. The system of claim 11, wherein said digital connection port comprises one or more of a Universal System Bus (USB) connector, a tip ring sleeve (TRS) connector, a memory card reader, a wireless transmitter/receiver, and a connection to a satellite broadcasting network

13. The system of any one of claims 2 to 12, wherein each of said one or more audio data files is a music file or a recorded sound file.

14. The system of any one of claims 1 to 13, wherein said audio signal controller sends said designated audio signal to an amplifier for amplification prior to output by said sound generator.

15. A method of operating a sound signal system for a motor vehicle having a remote control locking mechanism, comprising:
receiving a wireless signal using a receiver;
actuating a locking mechanism based upon the receiver receiving the wireless signal; and
playing a designated audio data file exterior the vehicle using a sound generator based upon the receiver receiving the wireless signal, wherein said receiver and said sound generator are original equipment manufacturer (OEM) components of said vehicle.

16. The method of claim 15, further comprising:
displaying one or more audio data files on a display in the interior of said vehicle; and
storing a selected one of said one or more audio data files as the designated audio data file.

17. The method of claim 16, wherein said display is an original equipment manufacturer (OEM) component of said vehicle.

18. The method of claim 16 or 17, wherein said display is a touch screen configured to receive touch input, and further comprising:
selecting the selected one of said one or more audio data files using said touch screen.

19. The method of claim 16 or 17, wherein said display has an input device associated therewith configured to receive input, and further comprising:
selecting the selected one of said one or more audio data files using said input device.

20. The method of claim 19, wherein said input device comprises at least one physical button.

21. The method of any one of claims 16 to 20, wherein each of said one or more audio data files is a music file or a recorded sound file.

22. The method of any one of claims 15 to 21, further comprising amplifying said designated audio signal using an amplifier prior to playing using said sound generator.

23. The method of any one of claims 15 to 22, wherein said actuating comprises at least one of locking the locking mechanism and unlocking the locking mechanism.
